(19) United States
(12) Patent Application Publication
(10) Pub. No.: US 2017/0310056 A1
(43) Pub. Date: Oct. 26, 2017

(54) ELECTRICAL CONNECTOR

(71) Applicant: Cheng Uei Precision Industry Co., Ltd., New Taipei City (TW)

(72) Inventors: SHENG-TSUNG YUAN, New Taipei City (TW); SHENG-NAN YU, New Taipei City (TW)

(21) Appl. No.: 15/135,483

(22) Filed: Apr. 21, 2016

(51) Int. Cl. H01R 13/6585; H01R 12/71

(52) U.S. Cl. CPC H01R 13/6585; H01R 12/71

(57) ABSTRACT

An electrical connector includes an insulating housing, a plurality of first terminals arranged in the insulating housing, a plurality of second terminals arranged in the insulating housing. Each of terminals includes a contact strip. The contact strip includes a middle-recessed concave surface. By using the structure of the middle-recessed concave surface to decrease the middle thickness of the terminals, the impedance of the terminals is improved and the noise interference of the terminals generated in the high-frequency transmission is efficiently reduced.

### BACKGROUND OF THE INVENTION

### 1. Field of the Invention

The present invention generally relates to an electrical connector, and more particularly to an electrical connector which can effectively reduce the interference of high-frequency transmission.

### 2. The Related Art

In order to unify electrical connectors of different equipments for improving universalities of the electrical connectors, USB (Universal Serial Bus) connectors are the most popular interfaces of current computers. The USB connectors support plug-and-play external buses. The USB connectors are used for connecting with many kinds of peripheral devices at present, including loudspeakers, telephones, game controllers, printers, tablet devices, cameras and so on. With the universality of the USB connectors, except for data transmission, the current USB are widely applied to the charging field.

With the development of the electronic industries, in order to make the USB connectors apply in different power supply devices more popularly, and solve the USB 2.0 connector drawback which need be distinguished an obverse surface from a reverse

surface to be inserted, and therefore an innovative USB Type-C connector is created. In order to make the USB Type-C connector realize dual orientation insertion, it is usually to set two rows of terminals in an insulating base, one of the two rows of terminals is mounted to a top of the insulating base, the other of the two rows of the terminals is mounted to a bottom of the insulating base. However, with the rise of signal transmission speed, it is easy to suffer the high-frequency interference because of the set of the two rows of terminals. Therefore, it is necessary to provide an USB connector with an improved terminals structure can efficiently decrease high-frequency interference.

### SUMMARY OF THE INVENTION

An object of the present invention is to provide an electrical connector capable of efficiently decreasing high-frequency interference. The electrical connector includes an insulating housing, a plurality of first terminals and a plurality of second terminals. The insulating housing has a base body and a tongue body protruded frontward from a middle of a front surface of the base body. The tongue body has a top surface and a bottom surface. Each of the terminals includes a contact strip. The contact strips of the terminals are located in at least one of the top surface and the bottom surface of the tongue body, respectively. The contact strip has a middle-recessed concave surface, the extension direction of the concave surface is same as the extension direction of the contact strip.

Another object of the present invention is to provide an electrical connector capable of efficiently decreasing high-frequency interference. The electrical connector includes an insulating housing, an upper row of terminals arranged in the insulating housing, and a lower row of terminals arranged in the insulating housing. Each of the upper row of terminals has an upper contact portion, the upper contact portion has an upper contact surface and a middle-recessed upper concave surface opposite to the upper contact surface, the extension direction of the upper concave surface is same as the extension direction of the upper contact portion. Each of the lower row of terminals has a lower contact portion, the lower contact portion has a lower contact surface and a middle-recessed lower concave surface opposite to the lower contact surface, the extension direction of the lower concave surface is same as the extension direction of the lower contact portion.

As described above, by using the structure of the middle-recessed concave surface to decrease the middle thickness of the terminals, the impedance of the terminals is improved and the noise interference of terminals generated in the high-frequency transmission is efficiently reduced.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with an embodiment of the present invention;

FIG. 2 is a perspective exploded view of the electrical connector of FIG. 1;

FIG. 3 is a perspective exploded view illustrating the structure of an insulating housing and an inner shielding shell assembly of the electrical connector of FIG. 1;

FIG. 4 is a perspective view showing the insulating housing and the inner shielding shell assembly of FIG. 3 being assembled together;

FIG. 5 is a perspective view showing a plurality of first terminals and a plurality of second terminals of the electrical connector of FIG. 1;

FIG. 6 is a top view of the plurality of first terminals of FIG. 5;

FIG. 7 is a bottom view of the plurality of the first terminals of FIG. 5;

FIG. 8 is a partially enlarged view of the plurality of first terminals of FIG. 5;

FIG. 9 is a perspective exploded view showing the insulating housing with the plurality of second terminals received therein, and a grounding element combined with the first terminals;

FIG. 10 is a front view of the electrical connector of FIG. 1;

FIG. 11 is a cross-section view taken from along the straight line X-X in FIG. 10; and

FIG. 12 is another perspective view of the electrical connector of FIG. 1.

### DETAILED DESCRIPTION OF THE PREFERRED EMBODIMENT

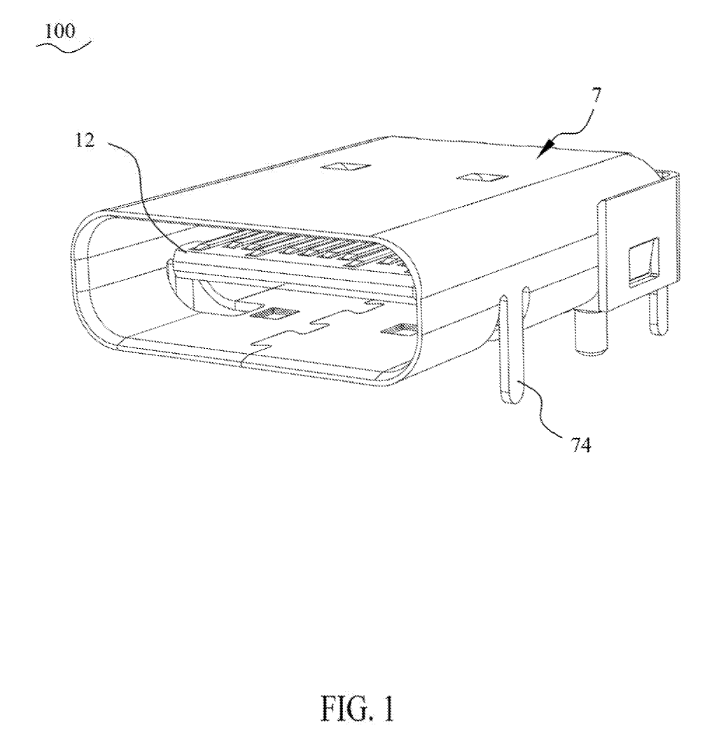

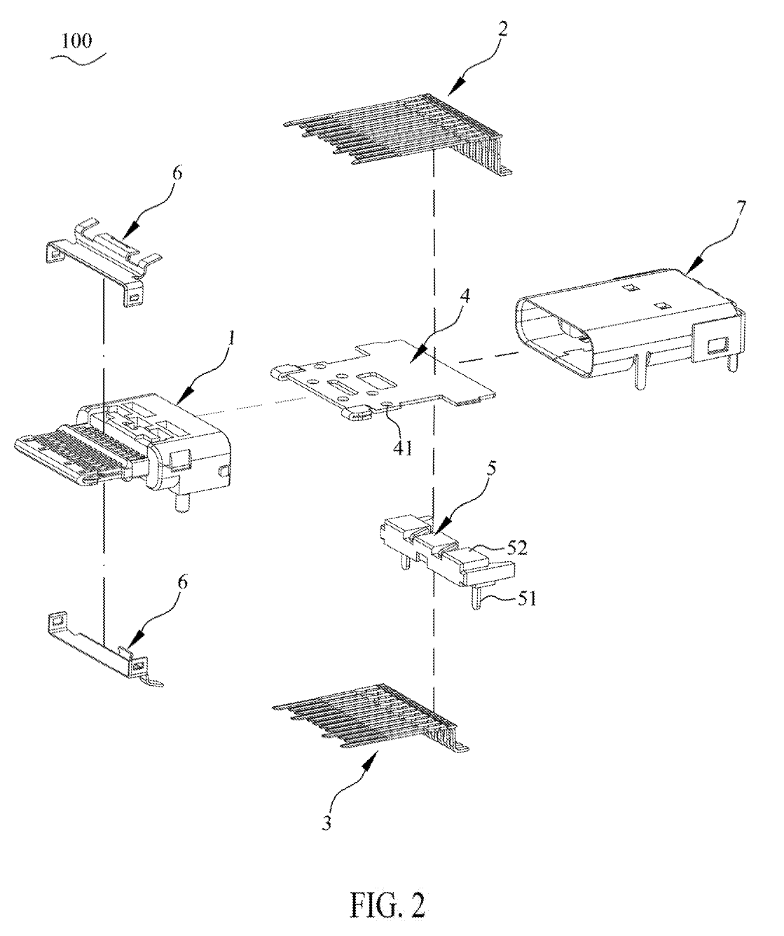

Please refer to FIG. 1 and FIG. 2, an electrical connector 100 in accordance with an embodiment of the present invention is shown. The electrical connector 100 mounted to a circuit board (not shown), includes an insulating housing 1, a plurality of first terminals 2, a plurality of second terminals 3, a middle shielding plate 4, a grounding portion 5, an inner shielding shell assembly 6 and an outer shielding shell 7. The plurality of first terminals 2 and the plurality of second terminals 3 are arranged in the insulating housing 1, the middle shielding plate 4 is mounted in the insulating housing 1 and located between the plurality of first terminals 2 and the plurality of second terminals 3, the grounding portion 5 is set under the middle shielding plate 4, the inner shielding shell assembly 6 is surroundingly fixed in the insulating housing 1, and then the outer shielding shell 7 envelops all the above components.

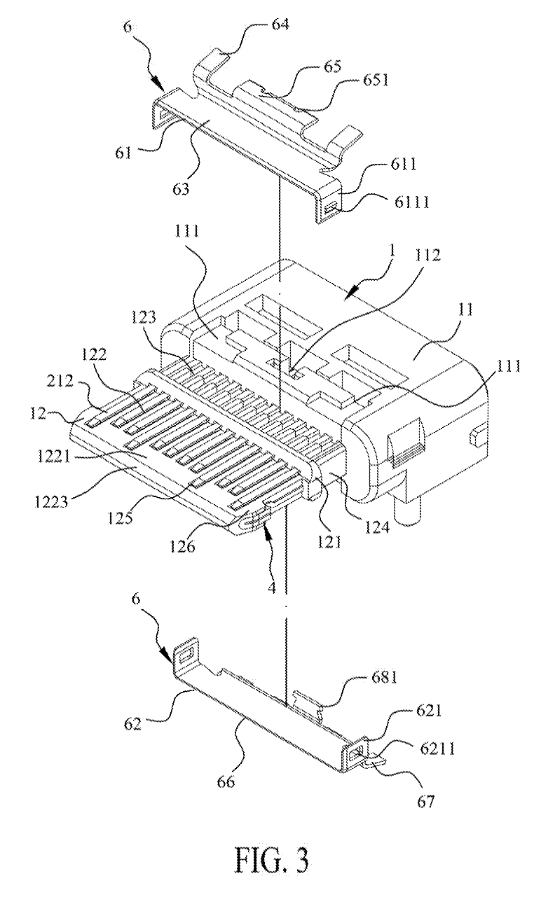

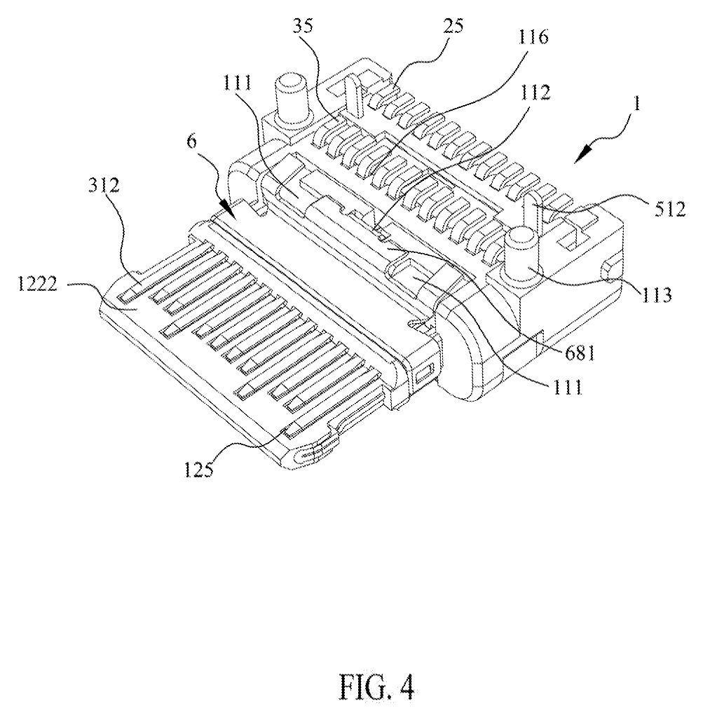

Please refer to FIG. 3 and FIG. 4, the insulating housing 1 includes a base body 11, and a tongue body 12 protruded frontward from a middle of a front surface of the base body 11, which is molded integrally by an insulating material. The base body 11 defines two recesses 111 which are formed in two sides of a front end of a top surface of base body 11. A middle of the top surface of base body 11 is concaved downward to form a locking groove 112 located between the two recesses 111. Similarly, a front end of a bottom surface of the base body 11 defines two recesses 111. A middle of the bottom surface of base body 11 is concaved downward to form a locking groove 112 located between the two recesses 111. In addition, two opposite sides of the bottom surface of the base body 11 protrudes downward to form two cylindrical locating pillars 113.

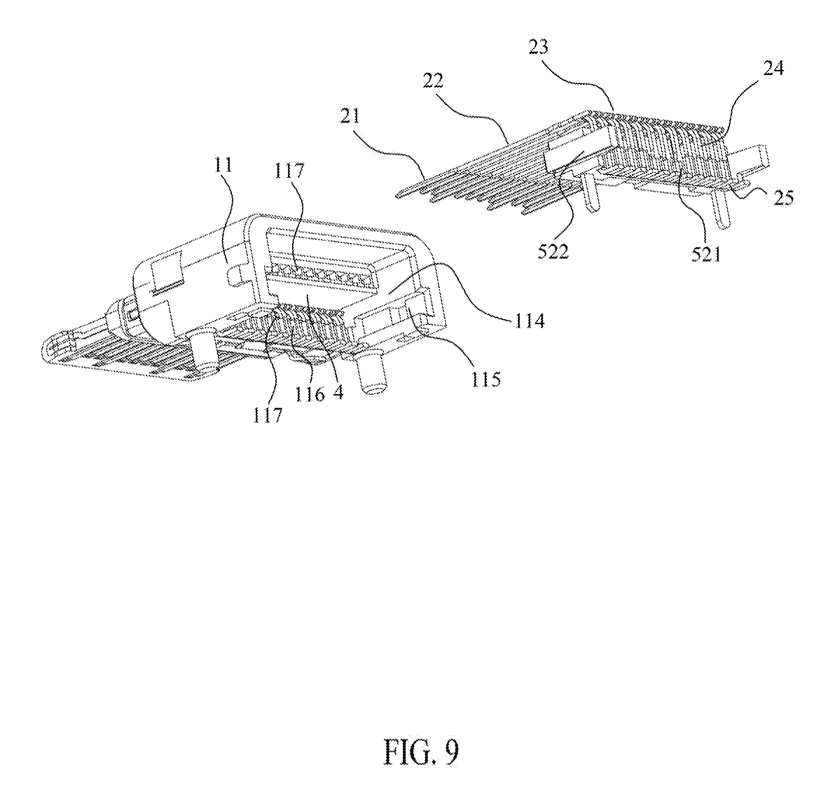

Please refer to FIG. 3 and FIG. 9, the base body 11 is provided with an assembling opening 114 penetrating a rear surface and the bottom surface of the base body 11. Two opposite side surfaces of the assembling opening 114 define two fixing grooves 115 extending front to rear. A plurality of terminal fixing grooves 116 are defined in a front surface of the assembling opening 114 and arranged transversely. The base body 11 defines an upper row and a lower row of terminal insertion holes 117 extending longitudinally and penetrating a front surface of the base body 11 and communicating with the assembling opening 114.

Please refer to FIG. 3 and FIG. 4, the tongue body 12 is protruded frontward from the base body 11. The tongue body 12 is provided with a ring-shaped blocking rib 121 which separates the tongue body 12 to a front section 122 and a rear section 123. A front area of the tongue body 12 located in front of the blocking rib 121 is defined as the front section 122, and a rear area of the tongue body 12 located behind the blocking rib 121 is defined as the rear section 123. And both sides of the rear section 123 each form a matching part 124. The tongue body 12 includes a top surface 1221, a bottom surface 1222 opposite to the top surface 1221 and a front surface 1223 connected with the top surface 1221 and the bottom surface 1222, a junction between the top surface 1221 and the front surface 1223 and a junction between the bottom surface 1222 and the front surface 1223 are chamfered. The tongue body 12 defines a plurality of longitudinal terminal grooves 125 in the top surface 1221 and the bottom surface 1222 thereof. The terminal grooves 125 communicate with the terminal insertion holes 117, respectively. The front section 122 of the tongue body 12 is further provided with two buckling parts 126 which are protruded outward from the two opposite sides of the front section 122, for butting the docking connector.

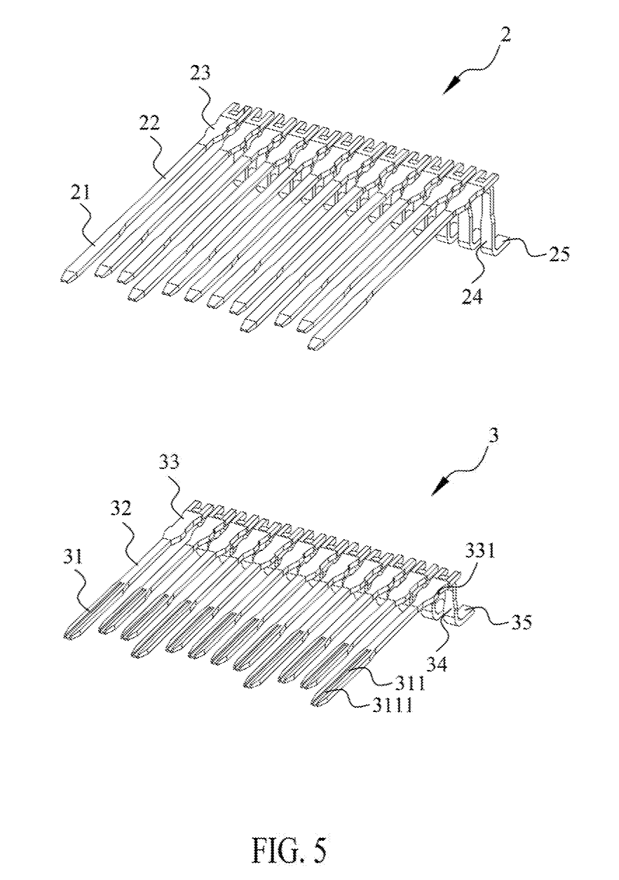

Please refer to FIG. 5, in this embodiment, the plurality of first terminals 2 and the plurality of second terminals 3 are stamped by metal material, which have the roughly same structure, each of the first terminals 2 and the second terminals 3 includes a contact strip 21,31, a connecting portion 22,32, a first fixing portion 23,33, a second fixing portion 24,34, and a soldering portion 25,35.

Please refer to FIG. 3 to FIG. 6, the contact strips 21 of the first terminals 2 are mounted in the terminal grooves 125 of the top surface 1221 of the tongue body 12. Each of the contact strips 21 of the first terminals 2 is extended rearward to joint one end of the connecting portion 22. Each of the connecting portions 22 is mounted between the tongue body 12 and the base body 11. The other end of the connecting portion 22 is jointed to one end of the first fixing portion 23. Each of the first fixing portions 23 is mounted in the corresponding each of the terminal insertion holes 117 of the base body 11. The other end of the first fixing portion 23 is bent and extended downward to form the second fixing portion 24. Each of the second fixing portions 24 is mounted on a terminal fixing base 521 of the grounding portion 5 (the grounding portion 5 will be described in detail below). The other end of the second fixing portion 24 is extended rearward to form the soldering portion 25, each of the soldering portions 25 exceeds the bottom surface of the base body 11 to be soldered to the circuit board (not shown).

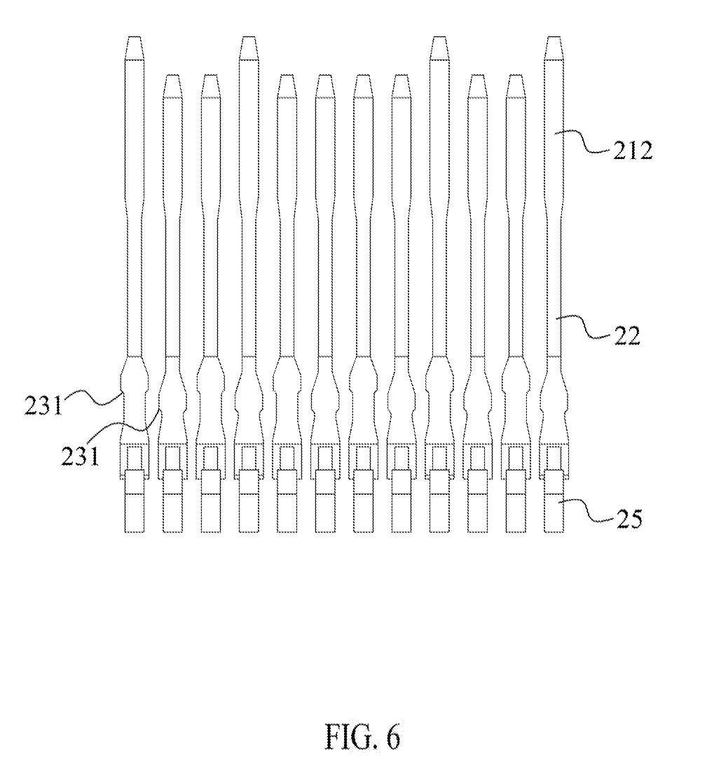

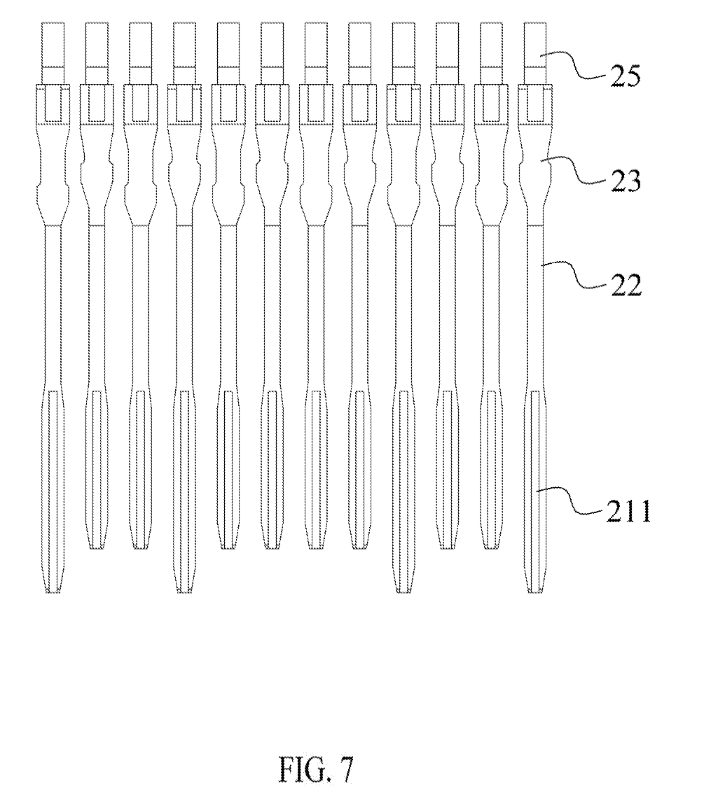

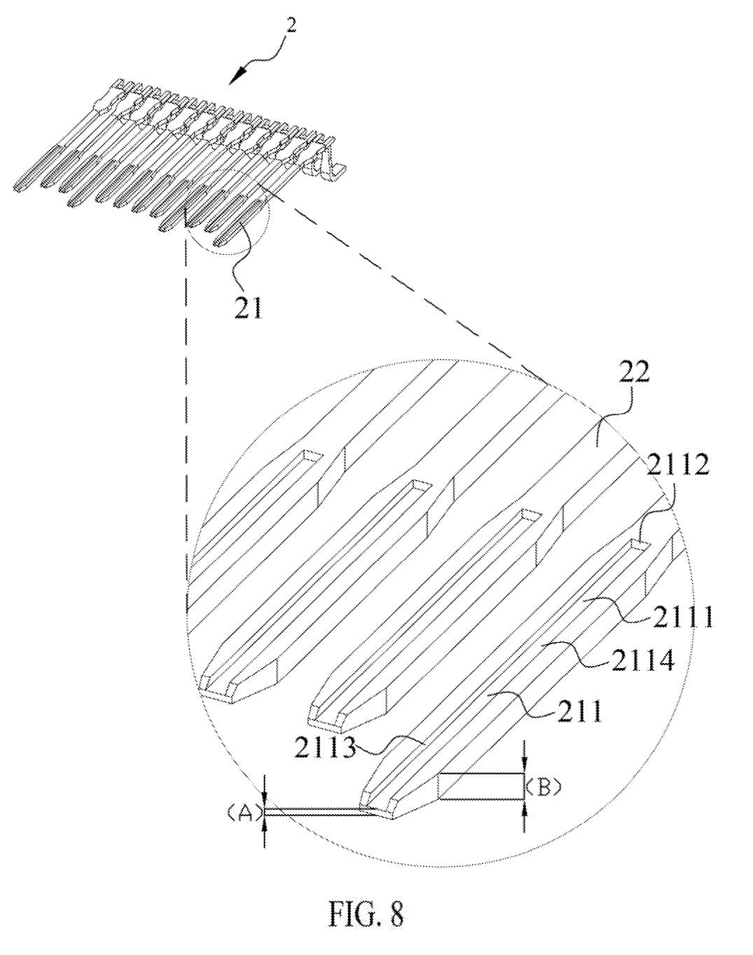

Please refer to FIG. 6 to FIG. 8, each of the contact strips 21 of the first terminals 2 includes a middle-recessed concave surface 211 and a contact surface 212, wherein the concave surface 211 is located in one side of the contact strip 21 and the contact surface 212 is located in an opposite side of the contact strip 21; the concave surface 211 is provided with a longitudinal groove 2111 which is depressed downward, the groove 2111 has the same extension direction as the contact strip 21. A surface of the groove 2111 adjacent to the connecting portion 22 is defined a posterior surface 2112. Two opposite side surfaces of the groove 2111 are define bilateral surfaces 2113. A recessed surface of the groove 2111 is defined a bottom surface 2114; wherein a thickness between the bottom surface 2114 of the groove 2111 and the contact surface 212 is defined as A, a bilateral thickness of the contact strip 21 is defined as B, hence, in this embodiment, by designing a structure of the groove 2111 to make the middle thickness A of the contact strip 21 is less than the bilateral thickness B, it can decrease the noise interference when the terminals transmit the high-frequency signals.

The contact strips 21 of the first terminals 2 are located in the terminal grooves 125 of the top surface 1221, wherein the contact surfaces 212 of the contact strips 21 face outward and exceed slightly the plane of the terminal grooves 125, and the concave surfaces 211 face insides of the terminal grooves 125.

Please refer to FIG. 5 to FIG. 7, the connecting portion 22 is a slender shape, the width of contact strip 21 is greater than the width of connecting portion 22, one end of the connecting portion 22 connecting the contact strip 21 is narrowed, thereby the impedance is improved when the high-frequency signals are transmitted. The other end of the connecting portion 22 connects the first fixing portion 23, two opposite sides of first fixing portion 23 includes two convex portions 231, the convex portions 231 of each adjacent two of the first fixing portions 23 are staggered with each other, by the staggered structure of the convex portions 231, the deformation from assembling is prevented.

Please refer to FIG. 4 and FIG. 5, the plurality of second terminals 3 have the approximately same structure as the plurality of first terminals 2, each of the contact strips 31 of the second terminals 3 also includes a middle-recessed concave surface 311 and a contact surface 312, wherein the concave surface 311 is located in one side of the contact strip 31, the contact surface 312 is located in an opposite side of the contact strip 31; the concave surface 311 is provided with a groove 3111 same as the groove 2111 of the concave surface 211, but the difference is that the concave surface 211 of the first terminal 2 and the concave surface 311 of the second terminal 3 are facing two opposite directions, moreover, the contact surface 212 of the first terminal 2 and the contact surface 312 of the second terminal 3 are also facing opposite directions, each of the contact surfaces 212 of the first terminals 2 is exposed from the top surface 1221 of the tongue body 12, and each of the contact surfaces 312 of the second terminals 3 is exposed from the bottom surface 1222 of the tongue body 12, consequently, the relation between the concave surfaces 211 of the first terminals 2 and the concave surfaces 311 of the second terminals 3 are opposite each other; at the same time, in this embodiment, the contact strips 21 of the first terminals 2 are set in the terminal grooves 125 of the top surface 1221, and the contact strips 31 of the second terminals 3 is set in the terminal grooves 125 of the bottom surface 1222.

Please refer to FIG. 2 and FIG. 9, the middle shielding plate 4 is provided with a plurality of holes 41. The middle shielding plate 4 is sheathed in the insulating housing 1 by injection molding, wherein the plurality of holes 41 are distributed symmetrically in a middle of the middle shielding plate 4 for fixing the middle shielding plate 4 and the insulating housing 1.

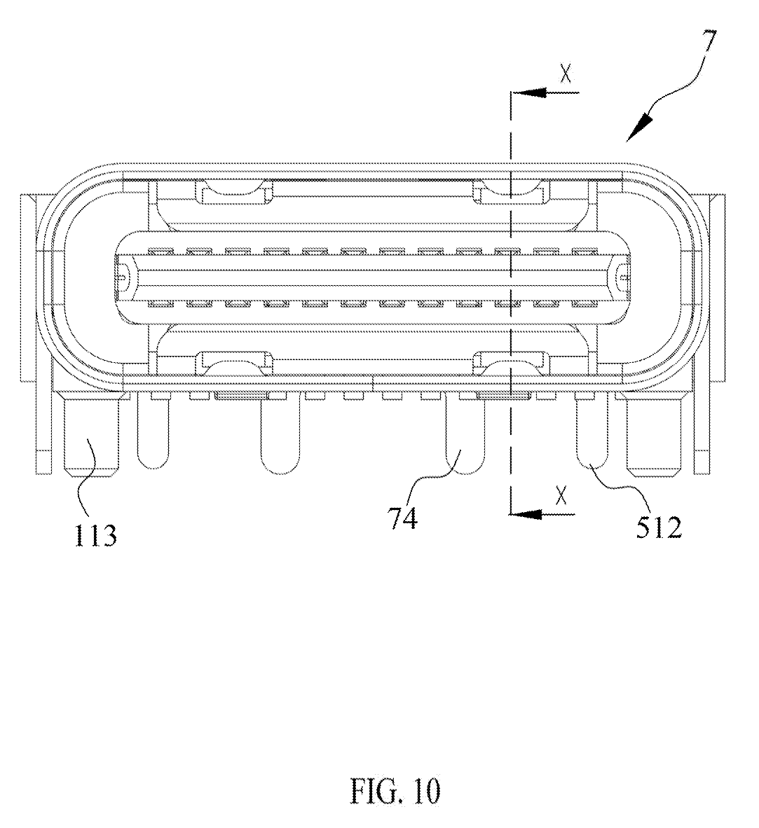

Please refer to FIG. 2, FIG. 9 to FIG. 11, the grounding portion 5 includes a conductive body 51 and an insulating body 52, in the present embodiment, the structure of the conductive body 51 is integrally stamped and becomes bending shape, the conductive body 51 is provided with a directed end 511 and a grounding end 512, the directed end 511 is exposed from a top surface of the insulating body 52 and the grounding end 512 is exposed from a bottom surface of the insulating body 52.

The conductive body 51 is sheathed in the insulating body 52 by injection molding, the insulating body 52 is provided with a plurality of terminal fixing bases 521 and two lateral fixing bases 522, the plurality of terminal fixing bases 521 with vertical shape are arranged at regular intervals in a rear surface of the insulating body 52; the two lateral fixing bases 522 are set in both sides of the insulating body 52.

Moreover, the directed end 511 of the grounding portion 5 contacts with the middle shielding plate 4 for grounding effect. In order to accomplish stable assembly, the plurality of terminal fixing bases 521 of the insulating body 52 are used to match the second fixing portions 24 of the first terminals 2, the two lateral fixing bases 522 of the insulating body 52 are also used to respectively match the two fixing grooves 115 of the base body 11; Meanwhile, the grounding portion 5 is positioned below the middle shielding plate 4 and the directed end 511 of the conductive body 51 contacts with the middle shielding plate 4; the grounding end 512 of the conductive body 51 protrudes downward to connect with the circuit board (not shown).

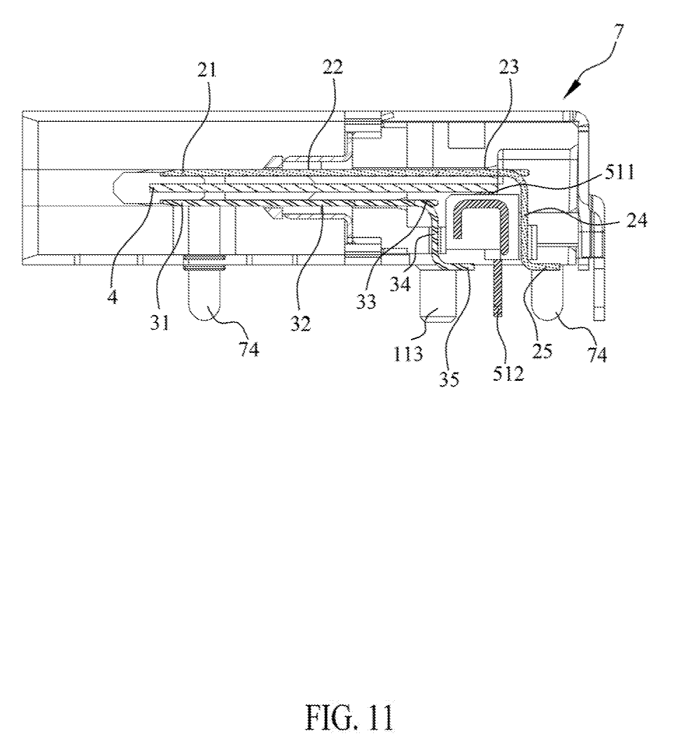

Please refer to FIG. 11, the plurality of first terminals 2 are set above and without contacting the middle shielding plate 4, and the second fixing portion 24 is positioned over a rear end of the middle shielding plate 4 without contacting each other; likewise, the plurality of second terminals 3 are set below and without contacting the middle shielding plate 4, and the second fixing portion 34 is also set under the middle shielding plate 4 without contacting each other, wherein the middle shielding plate 4 is located between the plurality of first terminals 2 and the plurality of second terminals 3 and spaced from each other, the grounding portion 5 is located between the second fixing portions 24 and the second fixing portions 34 for decreasing the high-frequency influence when terminal transmission.

Please refer to FIG. 2 and FIG. 3, the inner shielding shell assembly 6 is mounted in the rear section 123 and includes a first shielding shell 61 and a second shielding shell 62, the first shielding shell 61 and the second shielding shell 62 are located in the rear section 123, the first shielding shell 61 includes a first main plate 63, two opposite sides of the first main plate 63 of the first shielding shell 61 are bent downward to form two first buckling arms 611, the second shielding shell 62 includes a second main plate 66, two opposite sides of the second main plate 66 of the second shielding shell 62 are bent upward to form two second buckling arms 621; the two first buckling arms 611 are punched outward to form two buckling pieces 6111, and the two second buckling arms 621 define two buckling holes 6211, the buckling pieces 6111 and the buckling holes 6211 can fasten each other to make sure the inner shielding shell assembly 6 being securely mounted in the matching part 124. Moreover, two sides of a rear edge of the first main plate 63 are extended upward and further inclined rearward to form two resilient arms 64, a middle of the rear edge of the first main plate 63 are extended upward and then bent reward to form an auxiliary plate 65, a middle of a rear end of the auxiliary plate 65 is extended downward to form a locking portion 651 for buckling in one of the locking grooves 112 of the base body 11. Similarly, the second shielding shell 62 forms two resilient arms 67, an auxiliary plate 68, a locking portion 681.

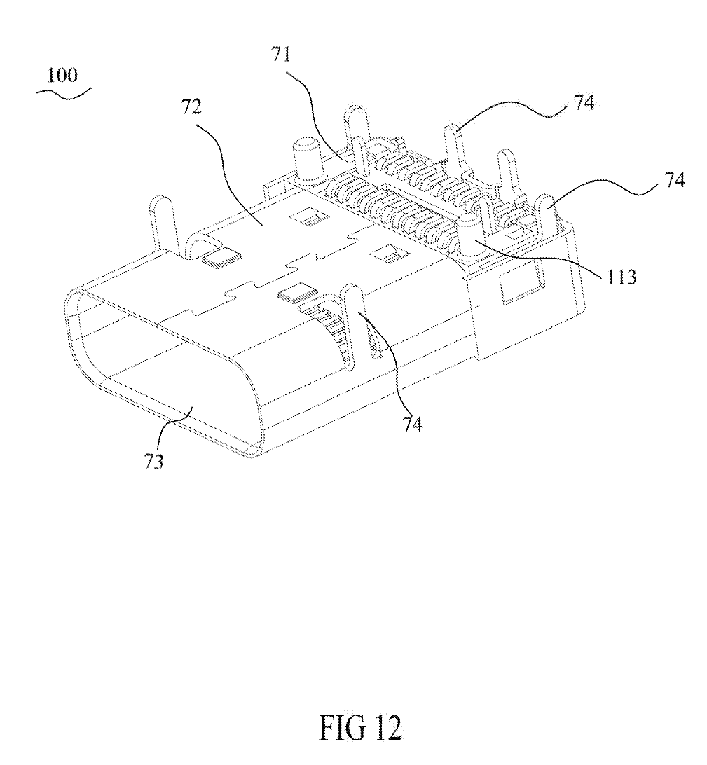

Please refer to FIG. 2, FIG. 11 and FIG. 12, the outer shielding shell 7 is made of metal and encircles the insulating housing 1 together with the plurality of first terminals 2, the plurality of second terminals 3, the middle shielding plate 4, the grounding portion 5 and the inner shielding shell assembly 6. The outer shielding shell 7 is provided with an installation portion 71 and a hollow-barrel shaped accommodating portion 72, the accommodating portion 72 is connected with a front end of the installation portion 71, and a front end of accommodating portion 72 forms a butting interface 73, a periphery of the outer shielding shell 7 defines a plurality of soldering feet 74.

As described above, the electrical connector 100 in accordance with an embodiment of the present invention, first, by stamping and bending to form the plurality of first terminals 2, the plurality of second terminals 3, the middle shielding plate 4, the conductive body 51, an inner shielding shell assembly 6 and an outer shielding shell 7, and then the middle shielding plate 4 is integrally molded in the insulating housing 1, the conductive body 51 is integrally molded in the insulating body 52, the plurality of second terminals 3 are mounted in the insulating housing 1, the contact strips 31 of the second terminals 3 and the connecting portions 32 of the second terminals 3 pass through the lower rows of the plurality of terminal insertion holes 117 of the base body 11, and the contact strips 31 of the second terminals 3 are set in the plurality of terminal grooves 125 of the bottom surface 1222 of the tongue body 12, wherein the contact surfaces 312 of the second terminals 3 exceed slightly the plane of the terminal grooves 125; the first fixing portions 33 are located in the terminal insertion holes 117, and the second fixing portions 34 of the second terminals 3 are fixed in the terminal fixing grooves 116 of the base body 11, the soldering portions 35 are bared in the bottom surface of the base body 11.

Then, the grounding portion 5 is assembled in the assembling opening 114 of the base body, and the two lateral fixing bases 522 of the grounding portion 5 are tenoned respectively in the two fixing grooves 115 of the base body 11; the plurality of first terminals 2 are mounted in the insulating housing 1, the contact strips 21 of the first terminals 2 and the connecting portions 22 of the first terminals 2 pass through the upper rows of the plurality of terminal insertion holes 117 of the base body 11, and the contact strips 21 of the first terminals 2 are set in the plurality of terminal grooves 125 of the top surface 1222 of the tongue body 12, wherein the contact surfaces 212 of the first terminals 2 exceed slightly the plane of the terminal grooves 125; the first fixing portions 23 are positioned in the terminal insertion holes 117, and the second fixing portions 24 of the first terminals 2 are fixed in the terminal fixing base 521 of the grounding portion 5, the soldering portions 25 are bared in the bottom surface of the base body 11.

And then, the inner shielding shell assembly 6 is mounted in the rear section 123 of the tongue body 12, the buckling pieces 6111 and the buckling holes 6211 fasten each other in the matching part 124, the locking portion 651,681 insert into the locking grooves 112 of the base body 11, the two resilient arms 64,67 are set in the corresponding recesses 111 of the base body 11. Finally, the insulating housing 1 is set into the outer shielding shell 7 and the installation portion 71 is located in the exterior of the base body 11, the accommodating portion 72 is located in the exterior of the tongue body 12, therefore the resilient arms 64,67 of the inner shielding shell assembly 6 can be against the outer shielding shell 7.

As described above, the purpose of in the present invention is solving the problem that the plurality of terminals are easy to be interfered by the high-frequency signals. In order to solve the problem, the present invention designs a structure that each of the contact strips of the terminals provided with a middle-recessed surface, the middle thickness of the contact strip is less than the bilateral thickness of the contact strip, which can efficiently improve the impedance of the terminals and reduce the noise interference of the terminals generated in the high-frequency transmission.

1. An electrical connector, comprising:
an insulating housing having a base body, and a tongue body protruded frontward from a middle of a front surface of the base body, the tongue body having a top surface and a bottom surface; and
terminals, each of the terminals including a contact strip, the contact strips of the terminals being located in at least one of the top surface and the bottom surface of the tongue body, respectively;
wherein the contact strip has a middle-recessed concave surface, the extension direction of the concave surface is same as the extension direction of the contact strip;
wherein the concave surface of the contact strip is provided with a groove in a middle thereof, the groove has the same extension direction as the contact strip, and the groove makes a middle thickness of the contact strip less than a bilateral thickness of the contact strip.

2. (canceled)

3. The electrical connector as claimed in claim 1, wherein the groove penetrates a front end surface of the contact strip.

4. The electrical connector as claimed in claim 1, wherein the top surface and the bottom surface of the tongue body define a plurality of terminal grooves arranged transversely for receiving the contact strips of the terminals.

5. The electrical connector as claimed in claim 4, wherein the contact strip includes a contact surface opposite to the concave surface and exposed from one of terminal grooves for contacting a mating terminal.

6. The electrical connector as claimed in claim 5, wherein a rear end of the contact strip connects a connecting portion, the width of the contact strip is greater than the width of the connecting portion.

7. The electrical connector as claimed in claim 6, wherein a rear end of the connecting portion connects a fixing portion, the fixing portion includes two convex portions formed in two opposite sides of the fixing portion, the convex portions of each adjacent two of the fixing portions are staggered with each other.

8. An electrical connector, comprising:
an insulating housing;
an upper row of terminals, arranged in the insulating housing, each of the upper row of terminals having an upper contact portion, the upper contact portion having an upper contact surface and a middle-recessed upper concave surface opposite to the upper contact surface, the extension direction of the upper concave surface same as the extension direction of the upper contact portion; and
a lower row of terminals, arranged in the insulating housing, each of the lower row of terminals having a lower contact portion, the lower contact portion having a lower contact surface and a middle-recessed lower concave surface opposite to the lower contact surface, the extension direction of the lower concave surface same as the extension direction of the lower contact portion;
wherein the upper concave surface is provided with an upper groove in a middle thereof, the upper groove has the same extension direction as the upper contact portion, and the upper groove makes a middle thickness of the upper contact portion less than a bilateral thickness of the upper contact portion, the lower concave surface is provided with a lower groove in a middle thereof, the lower groove has the same extension direction as the lower contact portion, and the lower groove makes a middle thickness of the lower contact portion less than a bilateral thickness of the lower contact portion.

9. The electrical connector as claimed in claim 8, wherein the upper contact surface and the lower contact surface are exposed from a top surface and a bottom surface of the insulating housing, respectively.

10. (canceled)
